(19) United States
(12) Patent Application Publication
(10) Pub. No.: US 2024/0033676 A1
(43) Pub. Date: Feb. 1, 2024

(54) SYSTEMS AND METHODS FOR BLOCKING, CONFINING AND DECANTING SUSPENDED DUST PRESENT IN AN AREA

(71) Applicant: QUANTUM MATRIX SPA, Santiago (CL)

(72) Inventor: Guillermo Sebastian GOMEZ VERDEJO, Santiago (CL)

(21) Appl. No.: 17/916,375

(22) PCT Filed: Mar. 31, 2020
(86) PCT No.: PCT/CL2020/050032

§ 371 Date: Sep. 19, 2023

(51) Int. Cl. B01D 49/00; G08C 17/02

(52) U.S. Cl. CPC B01D 49/003; G08C 17/02

(57) ABSTRACT

The present invention describes systems and methods for blocking, confining and settling suspended particulate matter less than 100 m, preferably less than or equal to 10 m, comprising irradiating with radio waves the medium in which said suspended particulate matter is present in order to destabilize it, causing blocking from one zone to another, confining and settling.

### FIELD OF APPLICATION

The present invention pertains to the field of environmental sciences, more particularly to primary atmospheric pollution such as fine suspended dust, whose size is less than 100 μm (microns) having an aerosol-like behavior. Specifically, the present invention relates to systems and methods for reducing atmospheric pollution because of present suspended dust or aerosols. The reduction of said particulate material is accomplished by blocking the material from one zone to another, by settling the material in a given or open zone and/or by confining the material in a given zone.

Specifically, the present invention relates to systems and methods for reducing atmospheric pollution by the effect of present suspended dust or aerosols. The reduction of said particulate matter is accomplished by means of the method of blocking the material from one zone to another, and, by the method of settling the material in a bounded or open zone and/or by confining the material in a set zone.

### BACKGROUND

Atmospheric particulate matter (PM) refers to a set of solid and/or liquid particles (except for pure water) present in suspension in the atmosphere (Meszaros, 1999). This PM is in atmospheric suspension due to its diameter, which ranges from 0.1 μm to 100 μm. Dust with a diameter greater than 100 μm is generally sedimentable. The PM produced by the mechanical action of the wind in desert or arid areas is dragged from the surface and incorporated into the atmosphere by atmospheric convection and circulation mechanisms, and can reach the upper layers of the atmosphere, moving for several kilometers. This PM has the particularity of being very light and is activated by the absorption of photon energy from solar radiation (electromagnetic waves), causing a balance of forces that allows the suspension of PM in a gaseous medium (air).

Particulate matter is made up of a heterogeneous set of components emitted by very diverse sources and the effects on the environment are also very varied. According to Spanish documentation, the most important among them are: the impact on health (Dockery et al., 1993; Schwartz, 1994 and 1996; Bascom et al., 1996; Dockery and Pope, 1996; Brunekreef et al., 1997; Kunzli et al., 2000; HEI, 2000; Lipfert., 2000; Wichmann and Peters, 2000; Hoek et al., 2002; Pope et al., 2002; WHO, 2003), on climate (Carlson and Benjamin, 1980; Penner et al, 1994; Sokolik and Toon, 1996; Meszaros, 1999; Arimoto, 2001; Wurzler et al., 2000; IPCC, 2001), effects on ecosystems by deposition (WBG, 1998), acidification and eutrophication, alteration of construction materials and coatings (Laurenzi Tabasso and Marabelli, 1992; Alastuey, 1994), and impact on visibility (White, 1990, Horvath, 1992).

In Chilean legislation (Decree 20 of Oct. 17, 2015), the emission standard for particulate matter to seasonal sources has been established. For its part, the Ministry of Health sets air quality standards aimed at preventing and controlling air pollution, in order to protect human health. These standards are applicable nationwide and provide the technical and administrative basis for the air pollution prevention and control system. The maximum allowable concentrations in the case of PM particulate matter are 75 μg/m³ as an annual concentration, 260 μg/m³ for a 24-hour arithmetic average concentration and 150 μg/m³ as a daily arithmetic average.

In particular, the emission of particulate matter is a constant in mining operations given the nature of these operations. During the mining processes of mineral extraction, mainly between blasting, loading, and unloading, transport and milling, a large amount of dust of different diameters is generated, including fine particulate matter (PM), which is sent to the environment.

The chemical and mineralogical composition of these particles varies from one region to another depending on the characteristics of the soils or rocks, but generally consists of: calcite (CaCO₃); quartz (SiO₂); dolomite [CaMg(CO₃)₂]; clays, mainly kaolinite [Al₂Si₂O₅(OH)₄] and illite [K(Al,Mg)₃SiAl₁₀(OH)]; feldspars [KalSi₃O₈ and (Na,Ca)(Al,Si)₄O₈]; lower amounts of calcium sulfate (CaSO₄×2H₂O) and iron oxides (Fe₂O₃) (Glaccum and Prospero, 1980; Schutz and Sebert, 1987; Adedokun et al, 1989; Avila et al, 1997; Caquineau et al, 1998). The origin of these particles is primary, as they pass directly into the atmosphere. In general, the composition of particulate matter of mineral origin is transported from desert regions and is usually enriched in clays, because of its longer atmospheric residence time due to its smaller particle diameter and its specific laminar morphology (Pósfai and Molnár, 2000).

Given the atmospheric pollution typical of mining operations, the best control and mitigation measures have been permanently sought to reduce the impacts of particulate matter on air quality, human health, and the environment.

Some of the mitigation initiatives to reduce the amount of particulate matter include watering the internal roads of the sites using different types of dust suppressants, direct humidification of the material to prevent the action of heavy equipment and trucks from generating suspended dust, use of foggers to humidify the loading area, implementation of metal container structures and plastic membranes in the crushers, and installation of a material storage dome, among others.

Despite these initiatives, there is still a need for systems and methods to significantly reduce the dust suspended in these places that are continuously generating this type of contaminants.

### SUMMARY OF THE INVENTION

The present invention proposes as a solution to the posed problem the reduction of suspended particulate matter by destabilizing the interaction forces of the suspended dust by acting on the energy barrier through the application of energy based on a set of radio waves.

Specifically, the present invention relates to systems and methods for blocking, confining, and settling suspended particulate material, by means of the transmission of a carrier energy in the form of a pulse which in turn contains two signals that are modulated with the carrier. One of the signals corresponds to a wave of a defined geometry, amplitude and pulse, which destabilizes the interaction forces and is used to settle the particulate material. The other signal is a wave of a defined geometry, amplitude and pulse, which is applied to block the particulate material, that is, to generate a curtain or barrier that prevents the passage of dust in the indicated size and concentration.

Both signals are applied jointly or separately by means of a carrier energy, depending on the application, through a transmission circuit via a transmitting antenna, and received through a receiving antenna. It considers the hardware and software elements necessary for the remotely controlled solution of radio wave emission in the defined area.

The elements that make up the transmission system are signal generators, preamplification driver, industrial communications, and control miniPC, radio amplifier, and transmission and receiving antennas. The systems are controlled automatically and remotely.

According to existing scientific information, electromagnetic energy affects electric charge. Therefore, the scientific principles involved are:
1. Electromagnetic energy transmitted in the form of a pulse, transmits quantity of motion, obeys the law of conservation of energy. When it passes through a medium composed of a gas (air)+particulate material, small movements are produced, which in turn cause shocks, in which interaction forces act.
2. The polarity and interaction forces of aerosols (particles smaller than 100 μm) are affected by pulsed electromagnetic waves.
3. The influence of electromagnetic waves, on fine particulate material, i.e.,<100 μm in terms of their absorption and interaction forces (electromagnetic) that can attract ions, atoms or molecules of foreign substances, breaks the forces that prevent them from gathering and settling, on the one hand, and on the other hand, can block the fine material.

The effect of breaking the electromagnetic containment barrier will depend on the intensity of concentration and granulometry, therefore, it is necessary to strengthen the power of the wave. For this, the hypotheses that have been developed and validated are:
Colloidal destabilization: it is possible to destabilize the interaction forces of the suspended particulate material, of bounded concentration and granulometry, by acting on the interaction forces, with an application of energy based on pulsed radio waves.
Particle blocking: Very low frequency waves, transmitted as pulses, with inverse phase, define a barrier or blocking to the material in particles of less than 100 μm.

### BRIEF DESCRIPTION OF THE FIGURES

FIG. 1: Representation of the effect of a wave on MP≤10 μm.

FIG. 2: Digital color photograph for particle counting.

FIG. 3: Photograph of FIG. 2 processed in grayscale.

FIG. 4: Schematic of the signal transmission circuit.

FIG. 5: Schematic design of the research reactor (column).

FIG. 6: Photograph of the research reactor (column).

FIG. 7: Distribution test plot for M1 Crushing sample, energy measurement applying radio waves.

FIG. 8: Distribution test plot for M1 Crushing sample, concentration measurement using radio waves.

FIG. 9: Overall baseline graph for M1 Crushing sample.

FIG. 10: Energy plot using frequency of 0.5 MHz and amplitude of 5 V/cm for M1 Crushing sample.

FIG. 11: Concentration graph using frequency of 0.5 MHz and amplitude of 5 V/cm for M1 Crushing sample.

FIG. 12: Energy graph using frequency of 0.5 MHz and amplitude of 7.5 V/cm for M1 Crushing sample.

FIG. 13: Concentration graph using frequency of 0.5 MHz and amplitude of 7.5 V/cm for M1 Crushing sample.

FIG. 14: Energy graph using frequency of 0.5 MHz and amplitude of 10 V/cm for M1 Crushing sample.

FIG. 15: Concentration graph using frequency of 0.5 MHz and amplitude of 10 V/cm for M1 Crushing sample.

FIG. 16: Representation of a defined zone for blocking, confining, and settling of PM.

FIG. 17: Schematic of the studied points: inside, perimeter and outside the established system.

FIG. 18: Graph of PM 10 concentration during the day for 3 days.

FIG. 19: Graph of PM 10 concentration as daily averages for 13 days inside and at the perimeter of the established system.

FIG. 20: Representation of a particular zone for blocking, confining and settling of PM.

FIG. 21: Photograph of the system for blocking particulate matter at a mining site.

### DETAILED DESCRIPTION OF THE INVENTION

The present invention relates to systems and methods for blocking, confining and/or settling suspended particulate matter.

In particular, the invention is directed to a system and method for blocking, confining and/or settling particulate material present in a given zone. This zone corresponds to a geometric volume defined by one or more antennas through which radio waves are transmitted, and one or more antennas for receiving radio waves, which, by means of the transmission energy, make it possible to delimit the zone containing the particulate material.

The system for this mode of the invention comprises:
one or more antenna(s) through which the radio waves are transmitted;
one or more radio wave receiving antenna(s),
one or more oscillator(s) generating destabilizing signal;
one or more curtain signal generator oscillator(s);
one or more signal mixer(s) and purifier(s) that mix the destabilizing signal with the curtain signal;
one or more amplifier(s) of the mixed signal;
one or more pulse electronic circuit(s) to output intermittent signals; and
one or more transmitter(s) comprising at least one carrier energy radio in the VHF or UHF bands.

The method for blocking, confining and/or settling in particulate material present in a given area comprises the following steps:
delimiting an area containing the particulate material by locating one or more antennas through which the radio waves are transmitted and one or more receiving antennas;
setting the pulse, geometry, and frequency of the curtain and/or destabilizing waves;
transmit a modulated signal (curtain wave+carrier wave) as energy needed to block the particulate matter;
optionally, transmit a modulated signal (destabilizing wave+carrier wave) to break the stabilization forces and settle the particulate material;
initiate the transmission and reception of the waves.

The present invention is also directed to a system and method for settling the particulate material present. This method allows only settling of the particulate material that is closer to the system, decreasing its effect as the distance to the system increases, since the suspended material is less affected by the emitted signal.

The system for settling suspended particulate matter comprises:
one or more antenna(s) through which the radio waves are transmitted;
one or more oscillator(s) generator(s) of destabilizing signal;
one or more curtain signal generator oscillator(s);
one or more signal mixer(s) and purifiers that mix the destabilizing signal with the curtain signal;
one or more amplifier(s) for the mixed signal;
one or more electronic pulse circuit(s) to output intermittent signals; and
one or more transmitter(s) comprising at least one carrier energy radio in the VHF or UHF bands.

The method for settling suspended particulate matter comprises:
locating one or more antenna(s) through which the radio waves are transmitted;
setting the pulse, geometry, and frequency of the curtain and/or destabilizing waves;
transmitting a modulated signal (curtain wave+carrier wave) as energy needed to block the particulate matter;
initiate the transmission and reception of waves.

### FUNDAMENTALS

### Aerosols

An “aerosol” is a colloidal suspension of liquid or solid particles in a gas. Smoke and dust are considered to be aerosols of solid particles. The interaction of the atmosphere with solar radiation creates absorption and scattering processes in aerosol-like particles (colloids). A particle absorbs a certain amount of energy from an incident electromagnetic wave and then emits another at a solid angle centered on that particle. As a result of the absorption, the electrical charges of these particles are affected. As a result of this and because of interaction forces, the fine material PM<100 μm remains suspended and does not sediment. For sedimentation to occur, it is necessary to act on the energy barrier.

Aerosols (fine dust composed of particles with size between 0.01 μm to 100 μm) have a colloidal behavior, as well as an excess surface charge acquired by adsorption and ionization processes in a dispersion medium. This excess surface charge affects the surrounding charges (ions) in such a way that ions of opposite sign (counterions) are attracted to the surface and those of the same sign (co-ions) are repelled.

The same occurs with dust, whereby solar radiation adsorbs energy and produces charges. This same phenomenon, together with the thermal agitation of the system, gives rise to a distribution of charges around the dust particle whose structure takes the form of an electrical double layer. This electrical double layer is formed by two regions called Rigid Layer (Stern 1920), Diffuse Layer (Gouy 1910, Chapman 1913) and constitutes the ionic atmosphere.

### Effect of Radiofrequency

Radio frequency (RF) has the property of achieving ionic charge displacements and the medium acts as the dielectric of a capacitor. In a given area of known cross-section, where the medium is air, RF is believed to have the ability to displace charges. The electromagnetic (EM) signal is attracted to the area where the charges are located and because this is an area of greater absorption of the signal produces a deformation of the signal. The greater the charge and the more stabilized the system, the greater the absorption of the wave and the greater the neutralization of the interaction forces.

Electromagnetic waves are a disturbance that transports energy, propagating through a medium, which in this case is air+particulate material. The waves are directed from a point of emission to a point of reception. For the waves to act on the particulate material by breaking the interaction forces in one case or blocking in the other, the following needs to be known:
1. The particle size of the particulate material.
2. The chemical composition of the particulate material.
3. The dielectric constant of the particulate material.

All these variables are obtained by means of known techniques.

Once the particulate material is characterized by means of these three variables, a Frequency Sweep test or GGV diagram is possible, which corresponds to an energy diagram as a function of a frequency sweep in the limits that have been a priori established. With this frequency sweep, the value of the signal frequency to be applied in the waves is determined.

Considering the above, the present invention proposes to destabilize the interaction forces of the suspended dust by means of the interaction on the energy barrier with an energy based on a set of radio waves.

The present invention bases its technology on the following observation: “A small particle (smaller than 100 μm, even smaller than 10 μm) absorbs a certain amount of energy from an incident electromagnetic wave (absorbs energy) and refracts (changes direction and speed) the wave”. As a result of such absorption, the electrical charges of these particles are affected, and two effects are produced:
i) The interaction forces that keep the particles in suspension are broken and they settle. This, according to a certain geometry, Amplitude, frequency, applied on a bounded field, destabilizes the interaction forces.
ii) At a certain frequency, amplitude, geometry applied over a bounded area a repulsion effect, barrier or curtain produces.

In conclusion, because of the application of waves, a destabilization of particulate material≤100 μm, particularly≤10 μm, is produced, and on the other hand, a curtain or barrier is created over particulate material≤100 μm, particularly≤10 μm.

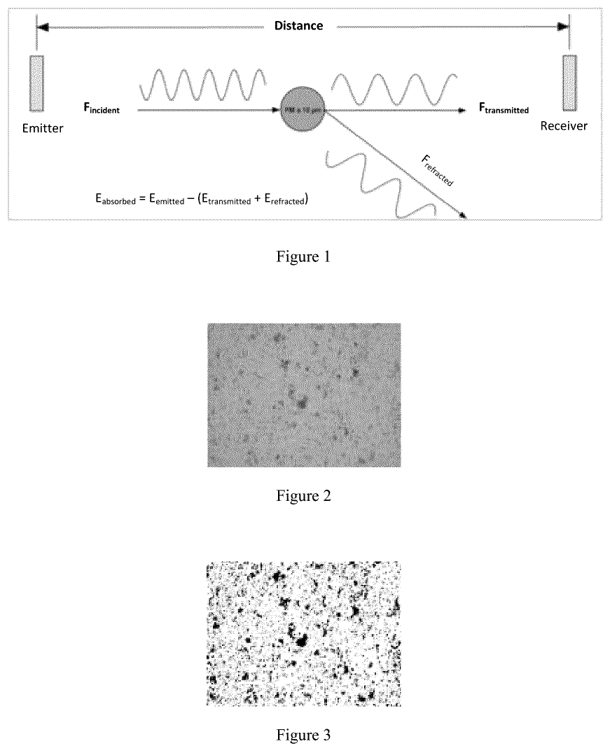

FIG. 1 explains the phenomenon of the wave effect on particulate material. A transverse wave, with peaks and valleys is shown. This electromagnetic wave is emitted by a frequency generator at a given frequency and Amplitude. This wave is emitted through an antenna and travels through a medium which is air containing suspended dust, when a wave collides with an obstacle, in this case air+suspended dust, in the direction it is propagating, the wave undergoes changes.

### Pulse Effect

There is a physical principle based on the quantity of movement that is the shocks. Pulsed radio waves accelerate the velocity of very small particles and cause collisions.

The collisions, resulting from the pulsed radio waves, break the interaction forces and destabilize the forces that prevent the particulate material from coalescing.

When the interaction forces are broken, it allows particulate material smaller than 100 μm to coalesce and settle by weight.

Settling will occur only if the particle force is greater than that of the wind.

As the wave carries more energy, it picks up more particles and increases in weight. The power is a function of the breakup since it causes more collisions by the amount of implied motion.

The particles that come together are called by us FLOC MP, to designate a set of particles that acquire weight by the sum of all of them and fall by the force of gravity.

The pulsed electromagnetic wave that is emitted, continues to act, and will collide with single particles and with FLOC MP. There will be more collisions, between particle with particle, Floc MP with Floc MP and, Floc MP with particle. All this helps to improve settling.

All this is valid for particulate material less than 100 μm, however, the higher the power the phenomenon should be proportional, i.e., it should influence the transition zone from particles>100 μm to<600 μm.

### Particle Counting-Segmentation Study

To perform particle counting an optical light counter is used through a high-resolution microscope, equipped with fluorescence, dark brightfield and phase contrast. It has a digital camera. The capture image is observed through software, and from the capture it has several tools related to image resolution such as filters and segmentation techniques. The microscope is isolated from air currents and in a thermally controlled environment. The sample is deposited by means of a dispenser onto an object holder. Once the image (FIG. 2) has been captured, fine-tuned, and adjusted, software is used to process and adjust the image for particle counting.

The algorithm that analyzes the image, by a digital camera, consists of the following basic steps to obtain the result:
a) conversion of the color image to grayscale (FIG. 3);
b) detection of the background in the image;
c) binarization of the image;
d) image segmentation;
e) particle counting; and
f) calculation of the concentration per volume.

With the color of each pixel in a digital image (Image 1 in colors) (FIG. 2) obtained by the camera is possible to obtain a final image (Image 2) (FIG. 3), corresponding to the conversion to grayscale to reduce the information. Then, in order to correctly identify the particles, it is necessary to identify the shades of gray that make up the background and those that belong to the particles.

The final collection is processed to obtain the information and statistics of the data.

What is relevant from the result of the particle counting is that the highest percentage of particle diameters of the suspended dust is between 2.5 μm and 10 μm, and that the total particles have a size that is less than 100 μm, particularly less than 70 μm.

### Radio Waves

According to the present invention the signal transmission is capable of emitting an analog or digital signal whose geometry may be sinusoidal, square, or triangular with amplitude varying between 1 V/cm and 25 V/cm.

The transmission can be made from a point A to be received at a point B of reception of the signal, thus preventing the passage of particulate material from one area to another (blocking).

The transmission of the signal can also be carried out without the need of a point B of reception of the same, in this way the transmission occurs until because of the distance the signal decays, so in the area closest to the transmission, the settling of the suspended particulate material will occur, which will decrease with distance until the suspended particles do not interact with the transmitted radio waves.

Another form of transmission can be made from at least one point A to at least one point B of reception, so as to delimit a zone, allowing within that zone the blocking and confinement of suspended particulate material. Depending on the parameters used such material can also settle.

The operation of the systems that use signal reception is based on the capacity of reception and digital tuning to find the signal sent, independent of the distortion induced by the environment. To achieve this, the transmitter(s) A′ send the digital data to the receiver(s) B so that they “know” the information sent by the analog channel. In this way, the integrated tuning system locates the independent signal. If the signal is distorted along the way, it can be corrected based on the transfer equation.

The power used for the transmission of the carrier wave will be around 0.5 W to 50 W, 5 W being preferably, which, according to the system, ensures a correct propagation of the signal allowing to obtain the signal distortion that needs to be determined in a better way.

As for the antennas considered in the system, several have been selected that have functionality such as high gain omnidirectional antennas, since, generally, in cases of multipath propagation there is a greater probability that the environment interferes with the radio frequency signal emitted, and this type of antennas decreases the possibility of these interferences to occur. Yaguis and FLAT panel antennas are also used. However, this does not rule out the use of other types of antennas, as a balance must be found between quality, RF link range and reception sensitivity to receive the signal.

In the case of a high gain omnidirectional antenna, it is manufactured with water and corrosion resistant materials and can be used indoors or outdoors, allowing its installation in base stations and wide area multipoint applications.

Depending on the area where the system of the present invention will be installed, the signal transmission frequency will be variable and can be selected from the VHF (30 MHz to 300 MHz) or UHF (300 MHz to 3 GHz) range. Generally, we have worked in the 460 MHz carrier wave frequency, a range that fits within the UHF band. These frequencies are open and allow us to have several options to work with depending on the physical location where the measurements are made. In turn, the digital data transfer rate considered is between 1,200 Bps and 2,400 Bps considering that this helps to maintain a secure and stable link.

If the sound waves were to be broadcast directly as electromagnetic signals, the antenna would have to be more than one kilometer high. By using much higher frequencies for the carrier wave, the size of the antenna is significantly reduced because higher frequencies have shorter wavelengths. This process is known as modulation.

Modulation encompasses the set of techniques used to carry information on a carrier wave, typically a sine wave. These techniques allow a better use of the communication channel, which makes it possible to transmit more information simultaneously, in addition to improving resistance against possible noise and interference. According to the American National Standard for Telecommunications, modulation is the process, or the result of the process, of varying a characteristic of a carrier wave in accordance with a signal carrying information. The purpose of modulation is to superimpose signals on the carrier waves.

Basically, modulation consists of making a parameter of the carrier wave change value according to the variations of the modulating signal, which is the information to be transmitted. The technique used for modulation in signal transmission is constant Amplitude and variable frequency, i.e., frequency modulation.

### Signal Transmission

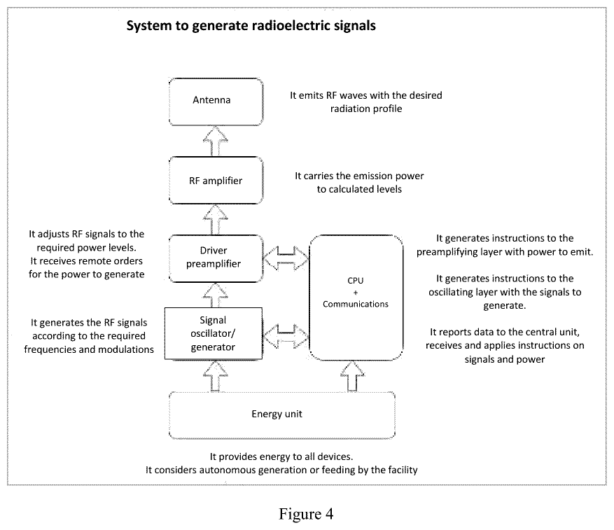

In the place where the antenna or antennas are located, a circuit is installed as shown in FIG. 4. The figure shows the wave generation system to produce the desired effect, which comprises
A power generating unit, whose purpose is to provide power to all devices. Generally, it is a stand-alone system, which can be photovoltaic, and/or electric power.
A signal generator oscillator. It generates the RF signals according to the required frequencies and modulations.
A preamplifier driver matches the signals to the required power level. It also receives remote orders on the power to be generated.
An RF amplifier (Radio transmitter) brings the emission power to calculated levels.
An antenna, which can be panel, yagui, omnidirectional or other for different uses.
This is associated with a CPU plus communications, to report data to the central unit and receives and applies signal and power instructions. It also generates the instructions to the oscillator layer to generate the signal and generates the instructions to the preamplifier stage to indicate the power to be output.

It is important to consider that the signal according to the present invention is carried in a medium containing particulate matter particles PM<100 μm. Any particle at a temperature different from absolute zero possesses a thermal energy that manifests itself as random motion or thermal agitation. In this case, aerosols are known to be colloids, colloids have charge, and charges are electrons. If the particles have charge as a product of electrons or dipoles, their random motion generates a random current. If this random current occurs in a conductive medium, a voltage known as “thermal noise or resistance noise” is produced. As expected, because of the wave-particle duality, there is thermal noise associated with electromagnetic radiation from the sun on the one hand, and noise caused by particulate matter on the other. For this, it is initiated by transmitting with one power (emission energy) and received with another or the same emission energy.

Whichever method is used to quantify, when the signal is emitted through an area with particulate matter, the noise must be quantified.

### Signal Reception

Signal reception is picked up directly by the receiving antenna which, in turn, transmits it to the radio.

The transmission procedure through the radio is a modulation. That is, the radio emits a carrier wave of known frequency and Amplitude varying from VHF to UHF using mainly the 400 MHz to 600 MHz range. The carrier wave emitted by the radio corresponds to a wave, generally sine wave, modified in some of its parameters (Amplitude, frequency, or phase) by an input signal called modulator in order to transmit information. This carrier wave is of a much higher frequency than that of the signal.

The reception of the signal at the antenna is transmitted to the radio and the latter, in turn, demodulates it in communication systems with DFT multicarrier modulation and transmultiplexers based on sine and/or cosine modulated filter banks, and the corresponding devices for transmitting and receiving signals for one or multiple users, with one or multiple transmission and reception stages.

### DESCRIPTION OF THE PREFERRED EMBODIMENTS

Before explaining the embodiments of the invention in detail, it should be understood that the invention is not limited in its application to the details of construction and arrangement of components indicated in the following description or illustrated in the figures. The invention permits other embodiments, as well as its implementation in various forms. It should also be understood that the terminology used herein serves descriptive purposes and should not be construed as restrictive.

The present invention refers to a system for blocking, confining and/or settling suspended particulate matter comprising:
one or more antennas by which radio waves are transmitted;
one or more radio wave receiving antennas;
one or more destabilizing signal generating oscillators;
one or more curtain signal generating oscillators;
one or more drivers (pulse controllers) and preamplifiers that adjust the power to required levels and receive remote commands, which also mix the destabilizing signal with the curtain signal;
one or more radio frequency amplifiers;
one or more transmitters comprising at least one carrier energy radio amplifier in the VHF or UHF bands.

In one embodiment of the invention, the arrangement of the antennas permits to create a delimited zone for blocking, confining and optionally settling the suspended particulate matter present in said zone.

In another embodiment of the invention, the arrangement of the antennas makes it possible to create a barrier or curtain which allows the blocking of the particles preventing the passage of one zone and the other created by the barrier or curtain.

In this case the antennas for transmitting radio waves are selected from panel antennas, omnidirectional, yaguis, dipole, among others.

In a preferred embodiment of the invention, the curtain signal wave operates at a frequency in the range of 1 Hz to 800 kHz.

In another preferred embodiment of the invention, the destabilizing signal wave operates at a frequency in the range of 18 kHz to 200 kHz.

In yet another embodiment of the invention, the carrier operates at a frequency in the VHF or UHF range, preferably in the range of 400 MHz to 600 MHz.

In one embodiment of the invention, the system further comprises a remotely controlled communications system.

In this case the particulate material has a particle size less than or equal to 100 μm, preferably less than or equal to 10 μm.

Furthermore, the present invention is directed to a method for blocking, confining and/or settling in particulate material comprising the following stages:
delimiting an area containing the particulate material by locating one or more antennas through which the radio waves are transmitted, and one or more receiving antennas;
setting the pulse, geometry, and frequency of the curtain and/or destabilizing waves;
transmit a modulated signal (curtain wave+carrier wave) as energy needed to block the particulate matter;
optionally, transmit a modulated signal (destabilizing wave+carrier wave) to break the stabilization forces and settle the particulate material;
initiate the transmission and reception of the waves.

The present invention is also directed to a system for settling and blocking suspended particulate matter, comprising:
one or more antennas by which radio waves are transmitted;
one or more destabilizing signal generating oscillators;
one or more curtain signal generating oscillators;
one or more drivers (pulse controller) and preamplifiers which adjust the power to required levels and receive remote commands and also mix the destabilizing signal with the curtain signal;
one or more radio frequency amplifiers;
one or more transmitters comprising at least one carrier energy radio amplifier in the VHF or UHF bands.

In one embodiment of the invention the curtain signal wave operates at a frequency in the range of 1 Hz to 800 kHz.

In another embodiment of the invention the destabilizing signal wave operates at a frequency in the range of 10 kHz to 50 kHz.

In another preferred embodiment of the invention, the carrier wave operates at a frequency in the VHF or UHF range, preferably used in the range of 400 MHz to 600 MHz. This energy is emitted by the radio frequency (radio) amplifier.

In yet another preferred embodiment of the invention the system further comprises a communications system with remote control.

In this case the particulate material has a particle size less than or equal to 100 μm, preferably less than or equal to 10 μm.

Additionally, the present invention is directed to a method for settling and blocking suspended particulate material comprising the following stages:
locating one or more antennas by which radio waves are transmitted;
fixing the pulse, geometry, and frequency of the curtain and/or destabilizing waves;
transmit a modulated signal (curtain wave+carrier wave) as energy needed to block the particulate matter;
optionally, transmit a modulated signal (destabilizing wave+carrier wave) to break the stabilization forces and settle the particulate material;
initiate the transmission of the waves.

### APPLICATION EXAMPLES

### Example 1

A laboratory level test was performed using a reactor (column) to destabilize suspended particulate material smaller than 10 p.m in a controlled manner.

The reactor comprises a vertical column with a diameter of 38 cm, an inner area of 1,134.12 cm² and a height of 1 meter. A system for measuring the concentration of ambient dust at different heights was installed in this column in order to construct the sedimentation curves, with wind speed and radiation control, which at a given humidity and temperature can insufflate dust in suspension so that light sensors can measure the energy and concentration every 10 centimeters over a length of 100 centimeters (1 m).

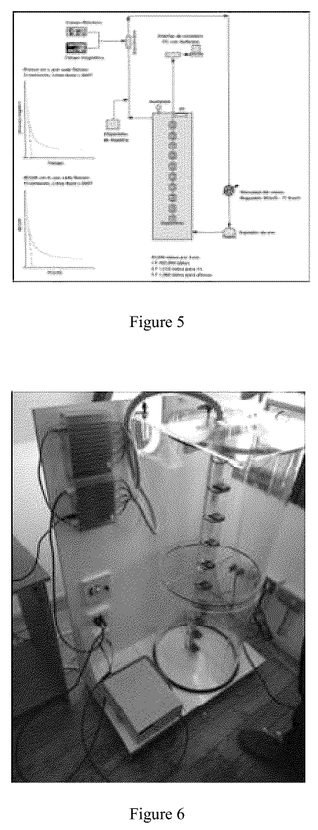

The reactor column consists of a series of equipment to simulate the conditions of a mining site, as well as equipment to measure and control the variables necessary to model the proposed solutions, which are detailed below. The column model used is shown in FIG. 5.

The column consists of:
a) A compressor to inject the powder sample into the column.
b) An air pump with blades to blow it at a defined wind speed.
c) An anemometer to regulate the wind speed to simulate real conditions.
d) A function generator to produce waves between 1 Hz and 3 MHz of sinusoidal, sawtooth, and square geometry, with Amplitude variation and other wave variables. It has an associated radio amplifier at the frequency of 450 MHz.
e) An oscilloscope to observe the emitted and received waves. With this to see the response effect by means of a transfer function.
f) A humidity and temperature meter to establish the humidity and temperature conditions of the test.
g) A UV radiation lamp to measure the amount of radiation supplied.
h) A system of AISI 316 L stainless steel electrode antennas for signal emission and reception.
i) Dust sensors.
j) A microprocessor that converts the signal captured by each sensor into a binary signal to be registered in a PC through a USB port.
k) Integrator software to process the data in real time, with measurement to the second.
l) 2-core controller PC for curve and graphics processing.

The system has 10 spectrophotometric sensors distributed in the center of the reactor that communicate through two data conversion interface boxes that allow emitting binary signals and transforming them to a decimal system through software that measures the amount of dust in suspension in the form of numerical information in real time.

The measurement system consists of a distribution of optical sensors capable of measuring the light distortion between an emitter and a receiver based on the level of airborne dust or smoke.

This system is designed to measure airborne dust in μg/m³ to be expressed as dust density.

The process starts with the loading of a dust sample in the research column and through the anemometer the wind speed is set. Once the wind speed is set, the dust particles are injected with the help of a high-pressure compressor. Recirculation takes place and the sedimentation rate curve detected by the sensors is measured. The PC receives the data and generates a table for each sensor. The measurements are continuous with data output every second.

The sensors are distributed at a height of between 10 and 90 cm from the base of the column, with 10 cm intervals between each one. These sensors are previously calibrated, emitting a beam of light that is received by a receiver in a cylindrical ring through which the powder passes. A microprocessor converts the signal captured by each sensor into a binary signal and an integrator program processes the data in real time. In this way, time-dependent data is available for each sensor, and at the same time, data is available for each height at a given time. A sensor at point X captures a certain concentration which decreases over time. In the same way, a sensor located at a point X-10 cm will determine that the concentration is increasing for the same time, but that it is also decreasing as a function of a longer time. On the other hand, sensors closer to the base of the column determine that the concentration is increasing.

To establish the baseline, a certain amount of dust was weighed and injected through a compressor into the column, after recirculation of air at a certain speed that simulates wind speed.

Once the baseline was established, we proceeded to determine the operational line, which repeats the same procedure of the baseline but differs by the application of an electromagnetic wave of radio frequency, of constant Amplitude of 1.5 volts and known geometry, that is, sinusoidal wave, although sawtooth and square wave can also be used. In this way, a second curve called activated line was obtained.

The operating procedure was as follows:
a) Weigh a quantity of powder;
b) Activate the air blower and adjust the wind speed with the regulator;
c) Connect the function generator to two electrode antennas separated by 10 centimeters through which the air-powder mixture would pass;
d) Inject the powder under pressure with the compressor. For this the previously weighed powder is put in the injector device that is connected to the compressor and expelled into the column;
e) Recirculate the injected powder for a certain time, which is subjected to the RF of known Amplitude and geometry, and then activate the measurement of all sensors;
f) Collect the data obtained every second.

To eliminate the possible contamination of dust from different sources of origin (pollen, organic and mineral particles) a measurement is made without applying dust or RF, only air, to calibrate the equipment.

The calibration and adjustment of experimental data was carried out using samples obtained from a mine for 21 days, choosing as collection point a crushing plant which will be called M1 Crushing.

Once the experiments were carried out, a data processing was performed to obtain an experimental data with samples of M1 Crushing.

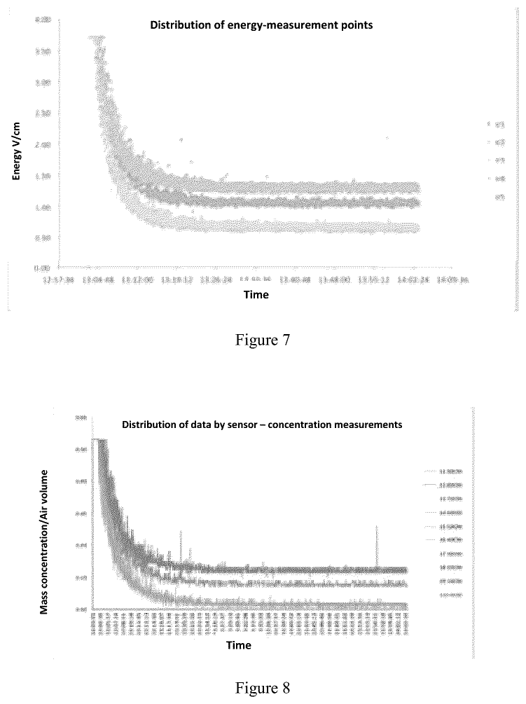

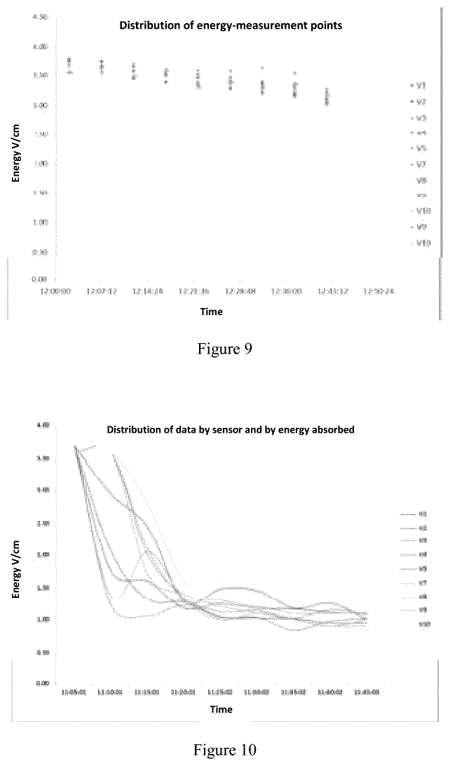

As a result of the calibration and adjustment of experimental data, it was observed that the curve has an asymptotic tendency to the Cartesian axis of the abscissa (see FIG. 7). For this reason, measurements were made up to 45 minutes, at 5-minute intervals. Considering this, a series of curves showing trends, expressed in energy versus time, and its counterpart of concentration versus time, are shown, which are expressed as data collection experiences. Thus, it is possible to observe the trends and to observe the behavior of the effect of the application of radio waves.

On the other hand, the experimental data were processed and shown in a summary, by means of which it is possible to observe the variation of the average concentration as a function of time, and thus obtain the sedimentation rate to finally determine the effect of the application of radio waves.

This study was carried out using a constant radiation of 5.1 kwh-m⁻²D, a constant wind speed of 5.5 km/h with the objective of minimizing variables, in order to demonstrate the destabilization of dust in suspension of less than 10 μm using electromagnetic energy. It was tried to maintain tests with constant temperature or as close as possible so that the measurements are comparable.

### Calibration and Adjustment of Experimental Data for M1 Crushing Samples

To calibrate the sensors, a correlation between the measurement of the emitted energy and the energy received at the sensor is used. For this, an infrared light is emitted through a diode which is captured by a phototransistor. The signal emitted by the sensor is measured in volts separated at a distance of one centimeter. Therefore, the emission is an electric field measured in Volts/cm. The received signal is also measured in volts. The equilibrium point is demarcated by a correlation plot between the energy measured in volts and the concentration measured in mg/m³ (see FIGS. 7 and 8).

As expected, particulate matter ≤10 μm has a very low settling velocity, so a linear trend parallel to the abscissa axis should be expected. For this, a sample quantity is taken such that it does not exceed the measurement capacity of the sensor.

According to FIG. 8, over time there is a decrease in concentration in the higher sensors and it becomes more concentrated in the lower sensors. Specifically, in this example, radio waves with a frequency of 500 KHz (0.5 MHz) with an Amplitude of 5 V/cm have been applied to the M1 crushing sample, recirculated with 15 to 20 minutes of exposure, and then stopped to collect data from the sensors.

### Results From Example 1

The results obtained, shown in FIG. 7, show a confluence of points that increases as the height decreases and decreases as the time increases when radio waves are applied; however, the tendency of the samples without application of radio waves is to remain in a suspended state.

In FIG. 7, the effect of applying radio waves of sinusoidal geometry, emitted by a function generator, and controlled by oscilloscope, can be clearly observed. The tendency at all points is to show a clear trend line whose curve obeys a polynomial of at least degree 4 with R=0.987, which explains that this process has its greatest effect in the first 45 minutes. FIG. 8 corresponds to the equivalent graph of FIG. 7, but in concentration measurements on the ordinate axis.

Considering this observed effect, all the data presented consider the measurement of up to 45 minutes of real time.

### Data Obtained for M1 Crushing Sample

The objective of these experiments is to observe the effect of the wave Amplitude in a wave configuration of sinusoidal geometry emitted by a function generator. The sample of M1 Crushing reached a density of 2.45 g/cm3.

Constant radiation and humidity were considered in the conduct of this study. Tables 1, 2, 3 show the data obtained, which are plotted and shown in FIGS. 10, 12, 14.
a) Energy of the M1 Crushing sample, applying radio wave with a frequency of 0.5 MHz and an Amplitude of 5 V/cm (see Table 1 and FIG. 10).

TABLE 1
Wind speed 5.5 Km/H-5 Hz-Amplitude 5-
V/cm-Humidity 60%-Temperature 16° C.

| T(min) | 90 | 80 | 70 | 60 | 50 | 30 | 20 | 10 | 0 |
|---|---|---|---|---|---|---|---|---|---|
| 5 | 0.53 | 0.53 | 0.53 | 0.53 | 0.53 | 0.52 | 0.52 | 0.52 | 0.52 |
| 10 | 0.24 | 0.33 | 0.24 | 0.24 | 0.17 | 0.52 | 0.52 | 0.28 | 0.31 |
| 15 | 0.11 | 0.18 | 0.13 | 0.12 | 0.16 | 0.31 | 0.29 | 0.28 | 0.31 |
| 20 | 0.14 | 0.16 | 0.11 | 0.14 | 0.11 | 0.17 | 0.13 | 0.14 | 0.20 |
| 25 | 0.07 | 0.14 | 0.12 | 0.11 | 0.07 | 0.11 | 0.08 | 0.11 | 0.18 |
| 30 | 0.8 | 0.13 | 0.09 | 0.10 | 0.12 | 0.12 | 0.08 | 0.09 | 0.15 |
| 35 | 0.07 | 0.11 | 0.07 | 0.11 | 0.06 | 0.09 | 0.06 | 0.09 | 0.15 |

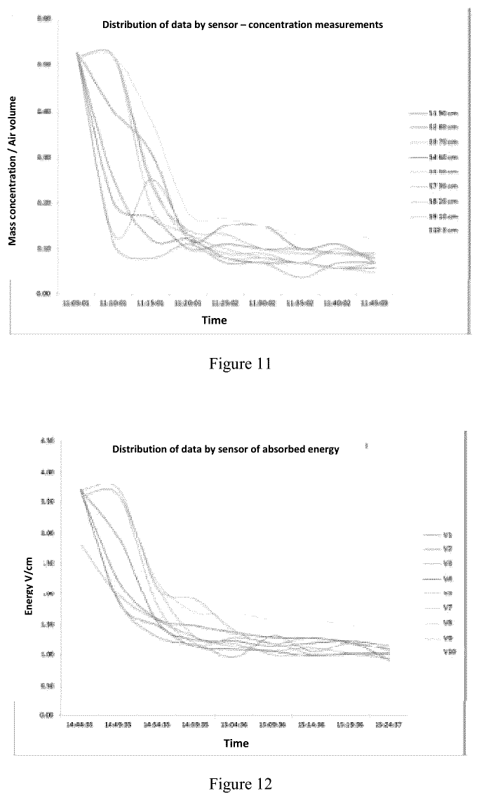

If we observe the results shown in FIG. 10, where a radio wave of 0.5 MHz frequency with an Amplitude of 5 V/cm was applied, it can be seen that the trend of the curve is a typical polynomial of order 4, which indicates a reduction in the concentration of particulate matter in all sensors and at different heights. It can be seen that ΔE≈(3.8 V/cm−1 V/cm)≈2.8 V/cm in only 5 minutes. The same data from Table 1 were taken to concentration and plotted in FIG. 11.

FIG. 11, the concentration counterpart for Crush M1, shows the same as FIG. 10 looked at as a driving force corresponding to the concentration difference between the highest and lowest point in a unit of time.

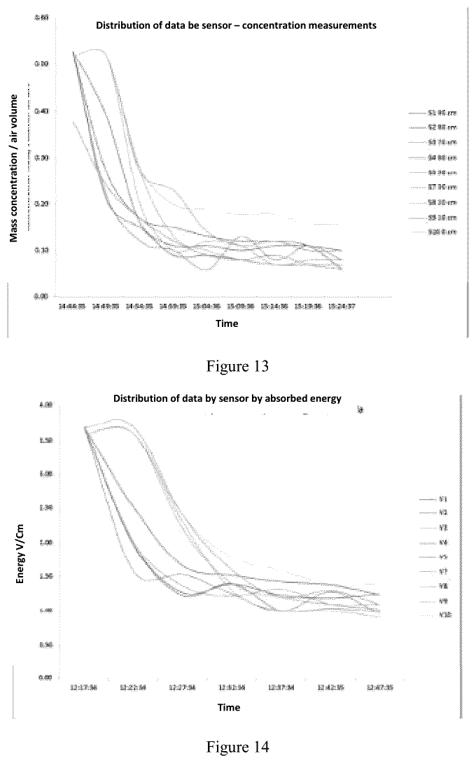

Energy of the M1 Crushing sample, applying radio wave with a frequency of 0.5 MHz and an Amplitude of 7.5 V/cm is shown in Table 2 and FIG. 12, and its concentration counterpart in FIG. 13.

TABLE 2
Wind speed 5.5 Km/H-5 Hz-Amplitude 7.5-
V/cm-Humidity 45.5%-Temperature 20° C.

| T(min) | 90 | 80 | 70 | 60 | 50 | 30 | 20 | 10 | 0 |
|---|---|---|---|---|---|---|---|---|---|
| 5 | 0.53 | 0.53 | 0.38 | 0.53 | 0.53 | 0.52 | 0.52 | 0.52 | 0.52 |
| 10 | 0.21 | 0.27 | 0.24 | 0.39 | 0.22 | 0.52 | 0.52 | 0.52 | 0.52 |
| 15 | 0.15 | 0.17 | 0.17 | 0.16 | 0.12 | 0.27 | 0.20 | 0.27 | 2.28 |
| 20 | 0.09 | 0.15 | 0.12 | 0.11 | 0.10 | 0.23 | 0.10 | 0.13 | 0.20 |
| 25 | 0.09 | 0.13 | 0.09 | 0.11 | 0.06 | 0.14 | 0.12 | 0.10 | 0.19 |
| 30 | 0.08 | 0.12 | 0.08 | 0.10 | 0.13 | 0.11 | 0.11 | 0.08 | 0.18 |
| 35 | 0.07 | 0.12 | 0.09 | 0.11 | 0.08 | 0.12 | 0.07 | 0.07 | 0.18 |

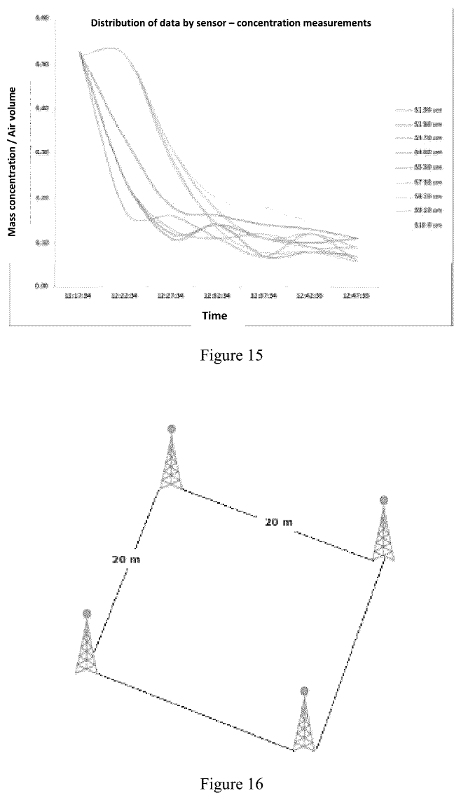

b) Energy of the M1 Crushing sample, applying radio wave with a frequency of 0.5 MHz and Amplitude of 10 V/cm is shown in Table 3, FIG. 14, and its concentration counterpart in FIG. 15.

TABLE 3
Wind speed 5.5 Km/H-5 Hz-Amplitude 10-
V/cm-Humidity 45.5%-Temperature 20° C.

| T(min) | 90 | 80 | 70 | 60 | 50 | 30 | 20 | 10 | 0 |
|---|---|---|---|---|---|---|---|---|---|
| 5 | 0.53 | 0.53 | 0.38 | 0.53 | 0.53 | 0.52 | 0.52 | 0.52 | 0.52 |
| 10 | 0.24 | 0.33 | 0.24 | 0.24 | 0.17 | 0.52 | 0.52 | 0.52 | 0.52 |
| 15 | 0.11 | 0.18 | 0.13 | 0.12 | 0.16 | 0.31 | 0.29 | 0.28 | 0.31 |
| 20 | 0.14 | 0.16 | 0.11 | 0.14 | 0.11 | 0.17 | 0.13 | 0.14 | 0.20 |
| 25 | 0.07 | 0.14 | 0.12 | 0.11 | 0.07 | 0.11 | 0.08 | 0.11 | 0.18 |
| 30 | 0.08 | 0.13 | 0.09 | 0.10 | 0.12 | 0.12 | 0.08 | 0.09 | 0.15 |
| 35 | 0.07 | 0.11 | 0.07 | 0.11 | 0.06 | 0.09 | 0.06 | 0.09 | 0.15 |

If we observe the baseline whose energy difference reaches ΔE≈0.6 V/cm in 43 minutes, we then have that the velocity ratio reaches 0.014 (V·cm⁻¹min). When the radio wave is applied, it can be observed that the energy difference reaches ΔE≈2.8 V/cm in 5 minutes, reaching a velocity ratio of 0.56 (V-cm-1-min). It can be seen that the effect of the waves with respect to the baseline, when a frequency of 0.5 MHz with an Amplitude of 5 V/cm is applied, increases the sedimentation rate of the particulate material 40 times.

The average velocity ratio for the baseline, in all experiments, is 0.0169 V·cm⁻¹min with a maximum of 0.028 V-cm⁻¹min and a minimum of 0.013 V-cm⁻¹min. The average velocity ratio for all samples for a frequency of 0.5 MHz and an Amplitude of 5 V/cm reaches a value of 0.369 V-cm⁻¹min with a maximum of 0.56 V-cm⁻¹min and a minimum of 0.32 V-cm⁻¹min. With these averages it can be said that, statistically, by means of the present invention the sedimentation rate increases 19 times when using an Amplitude of 5 V/cm, 21.7 times when using an Amplitude at 7.5 V/cm and 24 times when using an Amplitude of 10 V/cm. The trend is that as the Amplitude increases, the sedimentation rate ratio increases with respect to the baseline. Table 4 shows a summary of the sedimentation rate data obtained both from the baseline and for the three Amplitudes measured for the M1 Crushing sample.

TABLE 4
Sedimentation rate CRUSHING sample (mg/m³)/H

| Sample | | | 90 | 80 | 70 | 60 | 50 | 30 | 20 | 10 | 0 |
|---|---|---|---|---|---|---|---|---|---|---|---|
| Crushing | LB | | 0.08 | 0.08 | 0.08 | 0.08 | 0.08 | 0.08 | 0.08 | 0.08 | 0.08 |
| 1 | 5 | V/cm | 1.64 | 0.88 | 1.12 | 1.44 | 1.80 | 1.12 | 1.32 | 1.08 | 0.56 |
| | 7.5 | V/cm | 1.52 | 1.44 | 0.84 | 1.48 | 1.64 | 1.00 | 1.28 | 1.00 | 0.96 |
| | 10 | V/cm | 1.68 | 1.40 | 1.60 | 1.64 | 1.48 | 0.84 | 0.92 | 0.96 | 0.84 |

These results show that the sedimentation rate (expressed as mg·m⁻³H unit) for these samples is almost 21 times faster than that of the baseline.

### Conclusions From Example 1

By irradiating with radio waves with frequency of 0.5 MHz (50 kHz) and Amplitude varying between 5 V/cm and 10 V/cm, under conditions of constant radiation and humidity, and wind speed 5.5 km/h, the suspended dust particles are destabilized.
The interaction of the atmosphere with solar radiation (colloids) creates absorption and dispersion processes in the aerosol-like particles. A particle receives a certain amount of energy from an incident electromagnetic wave, absorbs a part of that energy and emits another part at a solid angle centered on that particle. As a result of the absorption, the electrical charges of the particles are affected, and a stabilization is produced that keeps them in suspension. When a radio wave is applied, the emitted energy resonates with the energy of the stabilizing forces, causing them to break, with the result of a significant increase in the sedimentation speed of the dust particles in suspension.
Radiofrequency has the property of achieving ionic charge displacements and the medium behaves like the dielectric of a capacitor. In a given area of known dimensions, in which the suspension medium is air, it has been demonstrated that radio frequency has the ability to displace charges. The electromagnetic signal identified as a radio wave selectively attracts the intensity. The greater the charge and the more stabilized the system, the greater the absorption of the wave and the greater the neutralization of the interaction forces. Therefore, the most important conclusion demonstrated is that it is possible to destabilize the interaction forces of the suspended dust by acting on the energy barrier with an energy based on a set of radio waves.
Obtaining a baseline parallel to the abscissa axis showing that the material remains in suspension in almost all cases, but this curve, when the procedure of the present invention is applied, causes a remarkable change whose velocity ratio is at least 20 times greater than the baseline.
For a closed system to which electromagnetic waves were applied, they showed a destabilization of interaction forces that allowed the sedimentation of the powder that is less than 10 μm, reaching to increase its sedimentation rate significantly.

### Example 2

To evaluate the behavior of the particulate material in a delimited area, the system and method of the present invention were tested in an open area within an open pit copper mining operation located in central Chile.

The system used consisted of:
4 towers located in an area formed by 20 m long, 20 m wide and 4 m high (see FIG. 16). Five transmitting (Tx) and five receiving (Rx) antennas were placed on each of these towers. A carrier wave is transmitted through each tower carrying two signals, a destabilizing signal to settle suspended dust, and a curtain signal to block ambient dust (<100 μm).

As an alternative to these 5 antennas per tower, a single transmitting and a single receiving antenna can be used.

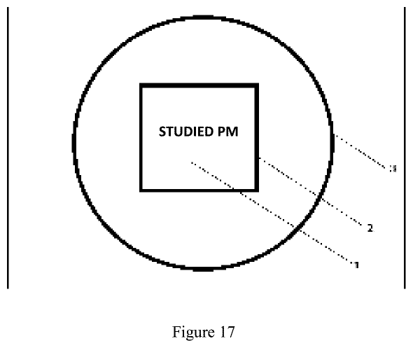

The amount of suspended dust, specifically 10 μm particulate matter, was measured. The monitoring stations were located at three different points, one inside the zone created by the 4 towers; one inside the zone where the 4 towers are located (MP area), one at the perimeter of the zone (edge) and one outside the zone, at 250 m, as shown in FIG. 17.

The behavior of suspended particulate matter was evaluated during the hours of operation and the concentration of PM 10 μm was determined at time 0, i.e., without applying the destabilizing signal, then at 30 minutes of operation and subsequently every hour.

The frequency of each of the waves used is shown below:

TABLE 5

| | Frequency |
|---|---|
| Curtain wave | 8 Hz |
| Destabilizing wave | 20 kHz |
| Carrier wave | 460 MHz |

### Results From Example 2

Table 6 shows the values obtained during three different and consecutive days, within the delimited zone created by the antenna arrangement.

TABLE 6

| Time (hours) | Day 1 (μg/m³) | Day 2 (μg/m³) | Day 3 (μg/m³) |
|---|---|---|---|
| 0 | 103.4 | 62.1 | 43.8 |
| 0.5 | 20.1 | 51.5 | 52.8 |
| 1.0 | 17.0 | 20.2 | 9.2 |
| 2.0 | 20.5 | 17.8 | 7.6 |
| 3.0 | 22.9 | 25.6 | 8.5 |
| 4.0 | 24.1 | 25.6 | 10.1 |
| 5.0 | — | — | 10.5 |
| 6.0 | — | — | 10.9 |

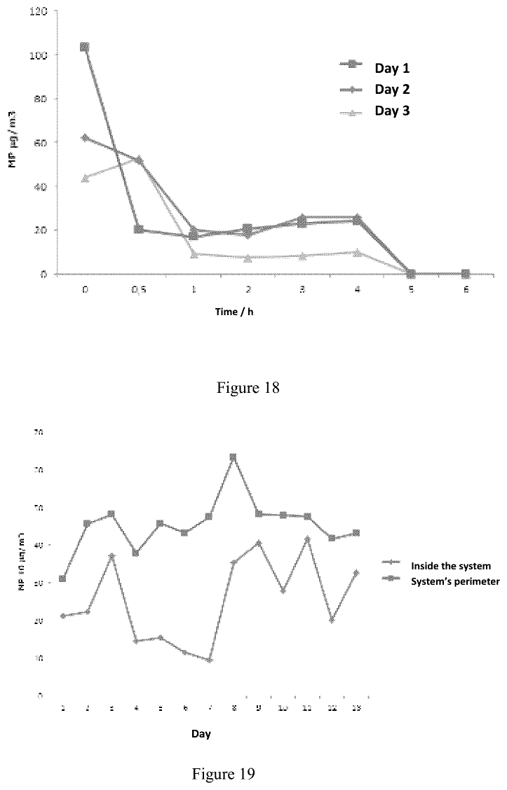

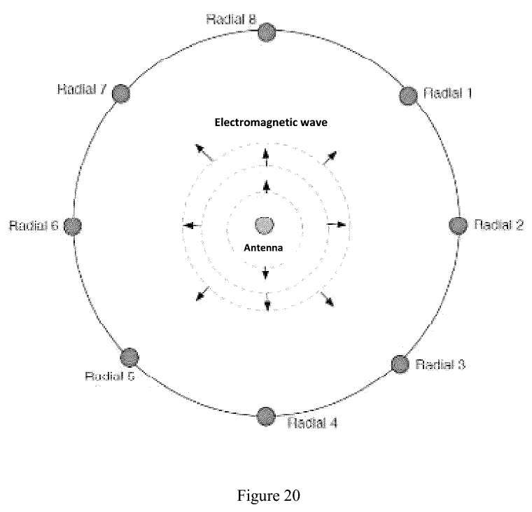

FIG. 18 shows the graph of measurements made giving account of behavior.

### Conclusions From Example 2

The results obtained show that once the emission of the electromagnetic waves generated by the radio waves is started, there is a significant decrease in the concentration of PM 10 μm, which indicates the destabilization of the aerosol type suspended particles producing their settlement. This destabilization occurs within the first hour of operation.
These results prove the presence of a curtain or blocking signal that prevents the passage of new particulate matter into the perimeter of the zone established by the antennas. This concentration remains constant and is independent of what happens outside the system.
The method developed not only causes the particulate material to settle within the area where the system is located, but also establishes a confinement zone where it is not possible for new contaminating material to enter, regardless of the type of work being carried out or the wind speed.

### Example 3

For the behavior of suspended particles inside and outside the zone established by the antennas to be comparatively determined, the concentration was measured every hour for 13 days, and the average for each day of measurement is shown in Table 7.

### Results From Example 3

Table 7 summarizes the data obtained both inside the zone delimited by the antennas and in the perimeter of the zone, and FIG. 19 shows the associated graph.

TABLE 7

| | PM 10 (μg/m³) | PM 10 (μg/m³) |
|---|---|---|
| Day | Inside the zone | Zone's perimeter |
| 1 | 21.1 | 31.1 |
| 2 | 22.3 | 45.6 |
| 3 | 37.2 | 48.2 |
| 4 | 14.5 | 37.8 |
| 5 | 15.4 | 45.8 |
| 6 | 11.5 | 43.2 |
| 7 | 9.5 | 47.4 |
| 8 | 35.4 | 63.4 |
| 9 | 40.5 | 48.1 |
| 10 | 27.8 | 47.9 |
| 11 | 41.6 | 47.6 |
| 12 | 20.0 | 41.6 |
| 13 | 32.6 | 43.0 |

### Conclusions From Example 3

The results obtained show that inside a zone created by the system the concentration of PM (10 μg) is lower than the concentration in the perimeter of that zone, which shows that inside the system the settlement of the material is greater, however, in the perimeter of the system there is also a settling effect.
The concentration of dust that remains inside the system is 56% lower than in the curtain or perimeter sector.
The destabilizing signal makes it possible to settle the suspended particulate matter found within the zone created by the system of the present invention.
The blocking signal allows to maintain the concentrations inside the system independently of the existing conditions, such as wind, type of operation, etc.

### Example 4

In order to demonstrate the efficiency of the system to block the passage of particulate matter from one area to another, two antennas, one transmitting and one receiving, were placed 50 meters from each other to create a barrier or blocking curtain at a mining site in northern Chile.

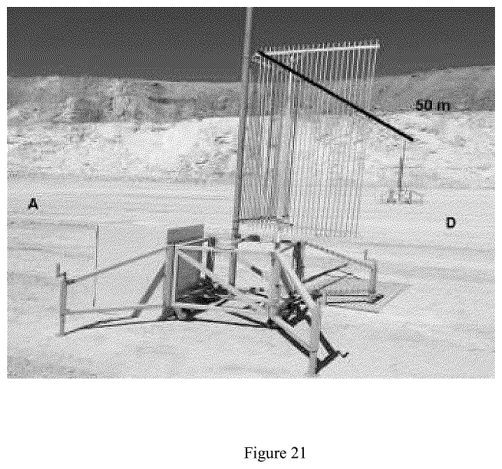

The system remained in operation for 8 hours, and the concentration of PM 10 was measured at a point before and after the barrier. A photograph of the system used can be seen in FIG. 21. The parameters used are shown in Table 8.

TABLE 8
Curtain test

| Description | Specification | Observation |
|---|---|---|
| Specific place | Mine | Mine pit, sector |
| Distance between antennas | meters | 50 |
| Mean before | μg/m³ | 40 meters before |
| Mean after | μg/m³ | 40 meters after |
| Curtain signal | Hz | 80 |
| Carrier signal | MHz | 460 |
| Pulse | mS | 0.5 |
| Efficiency | % | 69.3% |

Measurements were taken on two different days, every hour for 8 hours of system operation. The results are shown in Tables 9 and 10.

TABLE 9

| | Day 1 | | |
|---|---|---|---|
| Time | Before curtain/ | | Blocking |
| (Hours) | μg/m³ | After curtain/μg/m³ | efficiency/% |
| 9 | 264 | 132 | 49.9 |
| 10 | 130 | 38 | 70.7 |
| 11 | 121 | 36 | 70.4 |
| 12 | 91 | 11 | 88.0 |
| 13 | 34 | 7 | 80.1 |
| 15 | 32 | 8 | 75.8 |
| 16 | 32 | 16 | 50.0 |
| 17 | 32 | 8 | 75.4 |
| Averages | 92.0 | 32.0 | 70.0 |

TABLE 10

| | Day 2 | | |
|---|---|---|---|
| Time | Before curtain/ | After curtain/ | Blocking efficiency |
| (Horas) | μg/m³ | μg/m³ | 1% |
| 9 | 69 | 28 | 59.4 |
| 10 | 60 | 27 | 55.0 |
| 11 | 58 | 20 | 65.9 |
| 12 | 56 | 15 | 72.5 |
| 13 | 56 | 10 | 83.0 |
| e15 | 54 | 23 | 58.1 |
| 16 | 52 | 13 | 75.2 |
| 17 | 52 | 11 | 79.8 |
| Averages | 57.1 | 18.2 | 68.6 |

### Conclusions From Example 4

The system configured to get a blocking of particulate matter between one zone, and another allows an efficient and very significant decrease in the concentration of suspended particulate matter.
In order to create a curtain or screen that allows the blocking of the particulate matter, at least one antenna that emits the signal and one that receives it are necessary.
The efficiency of the method used is reproducible over time, since the values obtained on different days are consistent with each other.

By means of the description and examples shown, it can be appreciated that the present invention is a concrete and efficient solution to the problems of environmental pollution generated by particulate matter in suspension, which is present both in industrial operations and in neighboring settlements, generating immense and cumulative damage year after year.

1. A system for blocking, confining and/or settling suspended particulate matter, CHARACTERIZED in that it comprises:
one or more antennas through which radio waves are transmitted;
one or more radio wave receiving antennas;
one or more destabilizing signal generating oscillators;
one or more curtain signal generating oscillators;
one or more drivers (pulse controller) and preamplifiers that adjust the power to required levels and receive remote commands, which also mix the destabilizing signal with the curtain signal;
one or more radio frequency amplifiers;
one or more transmitters consisting of at least one carrier energy radio amplifier in the VHF or UHF bands.

2. The system according to claim 1, CHARACTERIZED in that the arrangement of the antennas makes it possible to create a delimited zone for blocking, confining and optionally settling the suspended particulate matter present in said zone.

3. The system according to claim 1, CHARACTERIZED in that the arrangement of the antennas allows the creation of a barrier or curtain that allows the blocking of the particles preventing the passage of one zone and the other created by the barrier or curtain.

4. The system according to claim 1, CHARACTERIZED in that the radio wave transmitting antennas are selected from panel antennas, omnidirectional, yaguis, dipole, among others.

5. The system according to claim 1, CHARACTERIZED in that the curtain signal wave operates at a frequency in the range of 1 Hz to 800 kHz.

6. The system according to claim 1, CHARACTERIZED in that the destabilizing signal wave operates at a frequency in the range of 18 kHz to 200 kHz.

7. The system according to claim 1, because the carrier wave operates at a frequency in the VHF or UHF range, preferably in the range of 400 MHz to 600 MHz.

8. The system according to any one of the preceding claims, CHARACTERIZED in that the system further comprises a remote-control communications system.

9. The system according to any one of the preceding claims, CHARACTERIZED in that the particulate material has a particle size less than or equal to 100 μm, preferably less than or equal to 10 μm.

10. A method for blocking, confining and/or settling in particulate material, CHARACTERIZED in that it comprises the following steps:
delimiting an area containing the particulate material by locating one or more antennas through which the radio waves are transmitted and one or more receiving antennas;
setting the pulse, geometry, and frequency of the curtain and/or destabilizing waves;
transmit a modulated signal (curtain wave+carrier wave) as energy needed to block the particulate matter;
optionally, transmit a modulated signal (destabilizing wave+carrier wave) to break the stabilization forces and settle the particulate material;
initiate the transmission and reception of the waves.

11. A system for settling and blocking suspended particulate matter, CHARACTERIZED in that it comprises:
one or more antennas through which radio waves are transmitted;
one or more destabilizing signal generating oscillators;
one or more curtain signal generating oscillators;
one or more drivers and preamplifiers which adjust the power to required levels and receive remote commands and also mix the destabilizing signal with the curtain signal;
one or more radio frequency amplifiers;
one or more transmitters consisting of at least one carrier energy radio amplifier in the VHF or UHF bands.

12. The system according to claim 11, CHARACTERIZED in that the curtain signal wave operates at a frequency in the range of 1 Hz to 800 kHz.

13. The system according to claim 11, CHARACTERIZED in that the destabilizing signal wave operates at a frequency in the range of 10 kHz to 50 kHz.

14. The system according to claim 11, CHARACTERIZED in that the carrier wave operates at a frequency in the VHF or UHF range, preferably used in the range of 400 MHz to 600 MHz. This energy is emitted by the radio frequency (radio) amplifier.

15. The system according to any one of the preceding claims, CHARACTERIZED in that the system further comprises a remote-control communications system.

16. The system according to any one of the preceding claims, CHARACTERIZED in that the particulate material has a particle size less than or equal to 100 μm, preferably less than or equal to 10 μm.

17. A method for settling and blocking suspended particulate material, CHARACTERIZED in that it comprises the following stages:
locating one or more antennas by which radio waves are transmitted;
setting the pulse, geometry, and frequency of the curtain and/or destabilizing waves;
transmit a modulated signal (curtain wave+carrier wave) as energy needed to block the particulate matter;
optionally, transmit a modulated signal (destabilizing wave+carrier wave) to break the stabilization forces and settle the particulate material;
initiate the transmission of the waves.
